(19) United States
(12) Patent Application Publication
(10) Pub. No.: US 2019/0025160 A1
(43) Pub. Date: Jan. 24, 2019

(54) DETERMINATION OF DAMPER HEALTH STATE USING INDIRECT MEASUREMENTS

(71) Applicant: GM Global Technology Operations LLC, Detroit, MI (US)

(72) Inventors: Robert P. Marble, White Lake, MI (US); Joseph K. Moore, Whitby (CA); Nojan Medinei, Toronto (CA); Martin Juhas, Ottawa (CA)

(21) Appl. No.: 15/656,408

(22) Filed: Jul. 21, 2017

(51) Int. Cl. G01M 17/04

(52) U.S. Cl. CPC G01M 17/04

(57) ABSTRACT

A system and method to determine the health state of a damper associated with a wheel of a vehicle using indirect measurements obtain information from one or more sensors. The one or more sensors includes a wheel speed sensor, inertial measurement unit, tire pressure sensor, steering wheel sensor, global positioning system (GPS) receiver, or a camera. The information from at least one of the one or more sensors includes at least one measurement of a parameter not directly characterizing the damper. The method also includes comparing the at least one measurement of the parameter with data of the parameter to estimate wear of the damper. The data includes a historical measurement, a measurement for another wheel of the vehicle, a measurement from another vehicle, or an output of a model, and a maintenance or replacement task is triggered by the estimate of the wear of the damper.

### INTRODUCTION

The subject disclosure relates to the determination of damper health state using indirect measurements.

The dampers of a vehicle refer to the shock absorption system. This shock absorption may be achieved with a mechanical or hydraulic device that is designed to absorb or damp shock impulses resulting from non-uniform road conditions. Each wheel of the vehicle (e.g., automobile, farm equipment, construction equipment, automated factory equipment) has a corresponding damper. As a result, each of the dampers of the vehicle may wear at a different rate based on the particular road conditions encountered by the corresponding wheel. This makes predictions of damper wear challenging in addition to direct measurements of the damper state. Accordingly, it is desirable to provide methods and systems for determination of damper health state using indirect measurements.

### SUMMARY

In one exemplary embodiment, a method of determining health state of a damper associated with a wheel of a vehicle using indirect measurements includes obtaining information from one or more sensors. The one or more sensors includes a wheel speed sensor, inertial measurement unit, tire pressure sensor, steering wheel sensor, global positioning system (GPS) receiver, or a camera, and the information from at least one of the one or more sensors includes at least one measurement of a parameter not directly characterizing the damper. The method also includes comparing the at least one measurement of the parameter with data of the parameter to estimate wear of the damper. The data includes a historical measurement, a measurement for another wheel of the vehicle, a measurement from another vehicle, or an output of a model, and a maintenance or replacement task is triggered by the estimate of the wear of the damper.

In addition to one or more of the features described herein, an event is detected based on the information, wherein the event includes a road excitation or a vehicle-based event.

In addition to one or more of the features described herein, the detecting the road excitation includes detecting a pothole or speed bump.

In addition to one or more of the features described herein, the detecting the vehicle-based event includes detecting braking or a door opening and closing to indicate entry of an occupant.

In addition to one or more of the features described herein, the comparing includes comparing the at least one measurement of the parameter with the data of the parameter during the event.

In addition to one or more of the features described herein, the comparing includes processing the at least one measurement and the data.

In addition to one or more of the features described herein, the processing includes performing a fast Fourier transform (FFT), filtering an output of the FFT, and obtaining a root-mean-square of an output of the filtering to obtain processed measurements of the parameter and processed data of the parameter.

In addition to one or more of the features described herein, the wear of the damper is estimated based on whether a difference between the processed measurements of the parameter and the processed data of the parameter exceeds a threshold.

In addition to one or more of the features described herein, the wear of the damper is quantified based on an amount by which the parameter exceeds the threshold.

In addition to one or more of the features described herein, a message is issued to indicate the estimate of the wear of the damper.

In another exemplary embodiment, a system to determine a health state of a damper associated with a wheel of a vehicle using indirect measurements includes one or more sensors to obtain information. The one or more sensors includes a wheel speed sensor, inertial measurement unit, tire pressure sensor, steering wheel sensor, global positioning system (GPS) receiver, or a camera, and the information from at least one of the one or more sensors includes at least one measurement of a parameter not directly characterizing the damper. The system also includes a processor to compare the at least one measurement of the parameter with data of the parameter to estimate wear of the damper. The data includes a historical measurement, a measurement for another wheel of the vehicle, a measurement from another vehicle, or an output of a model.

In addition to one or more of the features described herein, the processor detects an event based on the information, wherein the event includes a road excitation or a vehicle-based event.

In addition to one or more of the features described herein, the road excitation includes detecting a pothole or speed bump.

In addition to one or more of the features described herein, the vehicle-based event includes braking or a door opening and closing to indicate entry of an occupant.

In addition to one or more of the features described herein, the processor compares the at least one measurement of the parameter with the data of the parameter during the event.

In addition to one or more of the features described herein, the processor processes the at least one measurement and the data.

In addition to one or more of the features described herein, the processor processes the at least one measurement and the data by performing a fast Fourier transform (FFT), filtering an output of the FFT, and obtaining a root-mean-square of an output of the filtering to obtain processed measurements of the parameter and processed data of the parameter.

In addition to one or more of the features described herein, the processor estimates the wear of the damper based on whether a difference between the processed measurements of the parameter and the processed data of the parameter exceeds a threshold.

In addition to one or more of the features described herein, the processor quantifies the wear of the damper based on an amount by which the parameter exceeds the threshold.

In addition to one or more of the features described herein, the processor issues a message to indicate the estimate of the wear of the damper.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows the components involved in determination of damper health state according to one or more embodiments;

FIG. 2 is a process flow of a method of determining the health state of dampers of a vehicle according to one or more embodiments;

FIG. 3 is an illustration of a measurement used to determine the health state of a damper according to one or more embodiments; and

FIG. 4 illustrates the development of a benchmark that readily indicates a fault in a damper according to one or more embodiments.

### DETAILED DESCRIPTION

The following description is merely exemplary in nature and is not intended to limit the present disclosure, its application or uses.

As previously noted, the health state of the dampers of a vehicle is difficult to predict or measure directly. Yet, without any insight into the state of the dampers, the ride quality for a vehicle occupant can become dissatisfactory without warning that replacement or repair may be needed. In addition, the handling and stability of the vehicle can become negatively affected by wear of one or more of the dampers. Embodiments of the systems and methods detailed herein relate to determining the health state of dampers using indirect measurements. Based on the determination, maintenance tasks can be undertaken with reduced effect on the ride quality and vehicle stability.

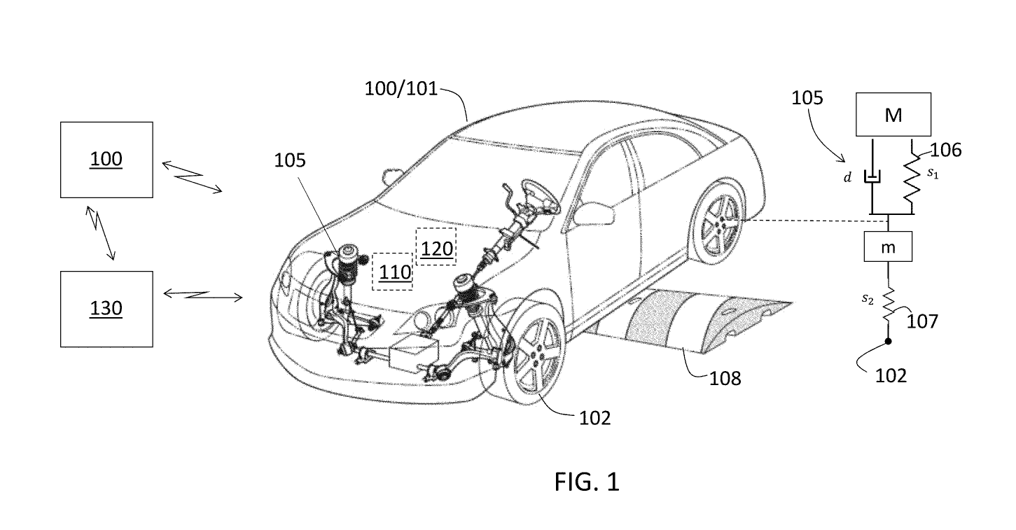

In accordance with an exemplary embodiment, FIG. 1 shows the components involved in determination of damper health state. The exemplary vehicle 100 shown in FIG. 1 is an automobile 101. The vehicle 100 is shown in the process of passing over a speed bump 108 in FIG. 1. The speed bump 108 represents a type of road excitation that is further discussed. The automobile 101 includes four wheels 102 and associated dampers 105. Several sensor systems 110 obtain measurements that are used in the determination of damper health state. Exemplary sensor systems 110 include the wheel speed sensor (WSS), inertial measurement unit (IMU), steering wheel sensor (SWS), and tire pressure monitoring system (TPMS).

The various sensor systems 110 are known and are not detailed here. The WSS is a type of tachometer that reads the speed of rotation of each wheel 102 of the vehicle 100. The IMU is an electronic device that measures vehicle motion such as longitudinal and lateral accelerations and yaw based on accelerometers and gyroscopes. The SWS provides the angle of the steering wheel. A combination of information from the SWS and IMU can be used to determine whether vehicle motion matches the commands issued via the steering. Oversteer or understeer may indicate an issue with the damper 105. The TPMS is an electronic system designed to monitor air pressure in the tire at each of the wheels 102. In addition to the exemplary sensor system 110 discussed above, the sensor systems 110 used in the determination of damper health state may include camera, radar, and lidar systems or other sensor systems 110 that provide information about current conditions such as road conditions, for example. A global positioning system (GPS) receiver is another exemplary sensor system 110 that may be used to determine the location of a road excitation, such as the speed bump 108, for example.

Components of the suspension system associated with each wheel 102 are shown in FIG. 1. A sprung mass M represents the mass of the vehicle 100 that is supported by the springs 106, 107. The damping d affects the main suspension spring rate s₁. The unsprung mass m represents the mass (e.g., wheel 102 mass) that is not supported by the spring 106. The spring rate of the wheel 102 is shown as s₂. A model representation of the damper 105 may be derived from dynamic equations based on displacements of the sprung mass M (and associated spring 106) and the unsprung mass m (and associated spring 107) as a result of xᵢₙₚᵤₜ(t) excitation from the road. An exemplary transfer function is given by:

$${H}_{model} ( s ) = \frac{G ( s )}{{X}_{input} ( s )} = \frac{{s}_{2}}{\frac{{( {s}_{1} + ds )}^{2}}{{Ms}^{2} + ds + {s}_{1}} + ( {ms}^{2} + ds + {s}_{1} + {s}_{2} )} \qquad [ EQ . 1 ]$$

In EQ. 1, Xinput(s) is the road excitation in the frequency domain and G(s) is the Laplace transform of velocity divided by angular wheel speed ω obtained by the WSS.

A processing system 120 obtains the measurements from the sensor systems 110. As shown in FIG. 1, the processing system 120 may additionally receive information from other vehicles 100 or a central server 130 that communicates with multiple vehicles 100. The processing system 120 may include an application specific integrated circuit (ASIC), an electronic circuit, a processor (shared, dedicated, or group) and memory that executes one or more software or firmware programs, a combinational logic circuit, and/or other suitable components that provide the described functionality.

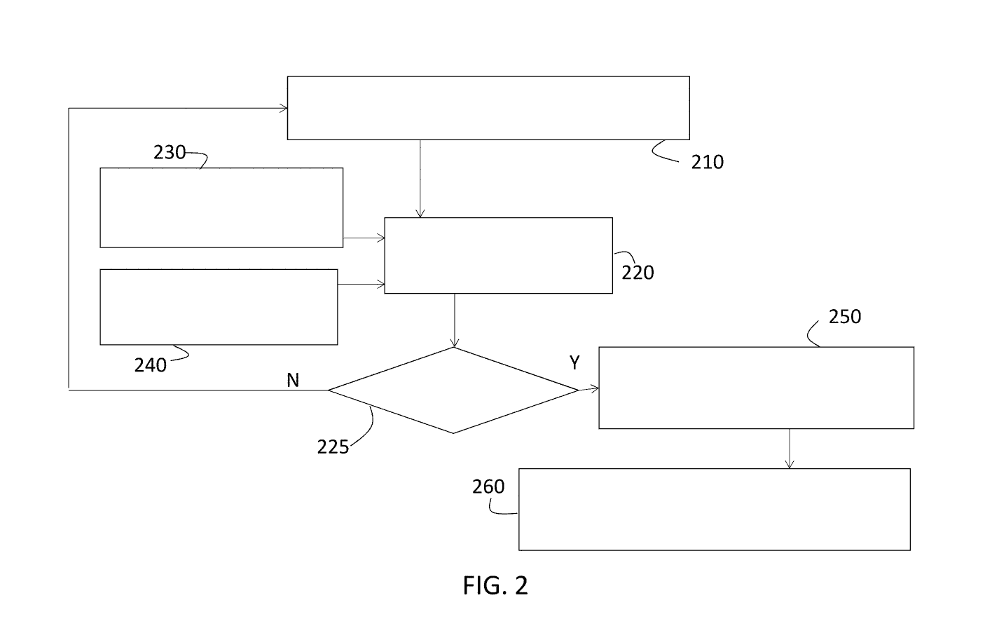

FIG. 2 is a process flow of a method of determining the health state of dampers 105 of a vehicle 100 according to one or more embodiments. The determination of health state is based on an estimation of wear and can be obtained from different information according to different embodiments. The determination may be based on information obtained entirely within the vehicle 100. According to alternate or additional embodiments, information from outside the vehicle 100 may also be used. The information from outside the vehicle 100 may be obtained from one or more other vehicles 100 or from a central server 130 or database, as further discussed with reference to the processes at blocks 240, 250, and 260.

At block 210, obtaining information from sensor systems 110 of the vehicle 100 includes obtaining measurements from sensor systems 110 like the WSS, SWS, and IMU. The information from sensor systems 110 includes one or more measurements of one or more parameters. The measurements do not directly characterize a damper 105. Obtaining event information, at block 230, may include obtaining information from sensor systems 110 that may indicate an event. An event may be, for example, a road excitation (e.g., pothole, speed bump 108), a vehicle 100 maneuver (e.g., braking), or another event (e.g., a door opening and closing, vehicle start). As such, the sensor systems 110 that facilitate identification of an event may include a camera or radar system, door sensors, and sensors associated with braking. What all the sensor systems 110 have in common is that none measures a parameter that directly provides the health state of the associated damper 105.

As FIG. 2 indicates, collecting the information, at block 220, includes obtaining event information, at block 230, or obtaining comparison information, at block 240, in addition to obtaining information from sensor systems 110. The event information and comparison information may be provided by another vehicle 100 or a central server 130 or may be obtained from the vehicle 100 entirely. For example, the sensor systems 110 of the vehicle 100 may indicate an event, as previously noted, and the measurements obtained for a front wheel 102 (at block 240) may be used as comparison information for measurements obtained for a rear wheel 102 (at block 210). Another vehicle 100 or a central server 130 may instead provide either the event information (at block 230) or the measurements used as comparison information (at block 240).

As previously noted, the event information refers to information indicating an event (e.g., road excitation) that may be in the path of the vehicle 100 whose dampers 105 are being analyzed. Comparison information refers to measurements of parameters associated with a different wheel of the same vehicle 100 or wheels 102 of other vehicles 100. The measurements may be associated with excitation events, for example. For example, the comparison information may include wheel speed data for another vehicle 100 while the vehicle goes over a pothole. At block 225, a determination is made about whether an event is detected among the information collected at block 220. If an event has not been detected (based on the check at block 225), then the process of obtaining information is continued.

If an event has been detected, then estimating the health state of one or more dampers 105, at block 250, is based on a comparison and predefined threshold. The comparison at block 250 involves comparing a measurement of a parameter (e.g., wheel speed, tire pressure) associated with a wheel 102 corresponding with a damper 105 with data. If the comparison does not indicate a match within a predefined threshold (i.e., difference between measurement and data values exceeds threshold), a level of wear may be indicated. That is, the amount by which the threshold is exceeded may be used to quantify a degree of wear of the damper 105. The specific data that the comparison involves is determined according to one of several embodiments. As noted previously, none of the measurements is of a parameter that directly characterizes the damper 105 (i.e., damping d).

According to one embodiment, one or more measurements (e.g., wheel speed, tire pressure) associated with the wheel 102 that experienced the event that was detected at block 225 are compared with model predictions of the measurements, historical measurements for that wheel 102, or with the same measurements associated with another wheel 102 that experienced the same event (e.g., the front wheel 102 when the back wheel 102 is being analyzed). Model predictions may be obtained from a model representation such as the previously discussed transfer function H_{model}(s) obtained according to EQ. 1.

According to an alternate embodiment, a comparison may be made with measurements taken for one or more wheels 102 of other vehicles 100 corresponding with the same event. For example, when a wheel 102 encounters an event related to a road excitation (e.g., bump, pothole), a parameter measured by a sensor system 110 (e.g., wheel speed, tire pressure) during the event may be compared with the same parameter measured for a wheel 102 of another vehicle 100 when it experienced the same event. If the parameter values are different by more than a threshold amount, then wear may be indicated.

According to other embodiments, the comparison (at block 250) may be based on information provided by a central server 130 regarding other vehicles 100 of the same vehicle model or type (e.g., similar weight). For example, a parameter value or range of parameter values may be provided by the central server 130 for the vehicle model. When the measured parameter fails to match the provided parameter value or range by a predefined threshold, a certain degree of wear of the damper 105 may be indicated. The central server 130 may average or otherwise consolidate information from multiple vehicles 100 rather than providing data for the vehicle model. Thus, obtaining information from sensor systems 110, at block 210, may include providing that information to the central server 130 to facilitate such consolidation.

Once an estimate of the health state is obtained for one or more dampers 105 (at block 250), the processes may include undertaking a maintenance or replacement task, at block 260. The processes at block 260 may include an informational message (e.g., human machine interface (HMI) message) to the driver or a fault code provided to a maintenance technician to facilitate the maintenance or replacement task.

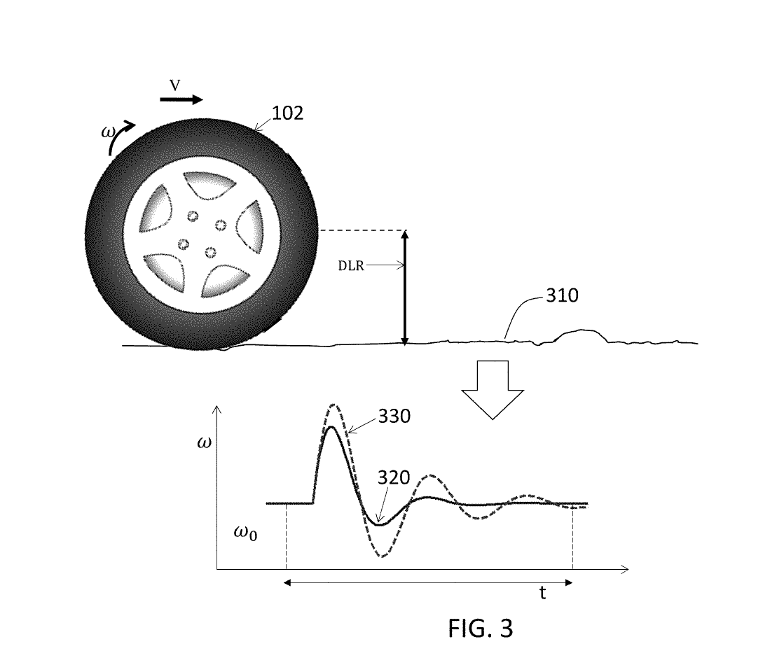

FIG. 3 is an illustration of a measurement used to determine the health state of a damper 105 according to one or more embodiments. FIG. 3 shows a wheel 102 and indicates angular wheel speed ω and velocity V of the vehicle 100. The dynamic loaded radius (DLR) of the wheel 102 is half of the theoretical rolling circumference divided by π and is a function of the disturbance of the road surface 310 and also the disturbance of the spindle (not shown). The spindle is the part of the suspension system that carries the hub for the wheel 102 and attaches to the upper and lower control arms.

Significantly, for the purposes of determining the health state of the damper 105 associated with the wheel 102 (at block 250), the displacement or disturbance of the spindle is a function of the damper 105 function. That is, the less worn the damper 105, the less displacement is exhibited in the spindle for the same event. The DLR is a function of the disturbance of the spindle, as noted previously. Further, the angular wheel speed ω is a function of velocity V of the vehicle 100 and DLR. Thus, while characteristics of the damper 105 and DLR cannot be measured directly, examination of the angular wheel speed ω, using the WSS, indirectly indicates the wear or health state of the damper 105.

The angular wheel speed ω over time shown as graph 320 represents data used for comparison, and the angular wheel speed ω over time shown as graph 330 represents a measurement associated with the damper 105 of interest. The graph 320 may be provided by a central server 130 based on a model or stored data following installation of new dampers 105, for example. The graph 320 may be provided by another vehicle 100 that experienced the same road surface 310. According to yet another embodiment, the graph 320 may be from another wheel 102 of the same vehicle 100 (e.g., the front wheel) or based on historical data stored for the wheel 102 during previous trips over the same road surface 310. A GPS receiver may be one of the sensor systems 110 used to determine the location of the particular stretch of road surface 310 used for the comparison.

As FIG. 3 indicates, the graph 320 indicates less intense disturbances and faster damping in comparison with graph 330. If the difference in graphs 320 and 330 (e.g., area under the graphs for the time t of interest) exceeds a threshold difference, then wear of the damper 105 associated with the wheel 102 shown in FIG. 3 may be at a level that warrants a message regarding replacement or maintenance (at block 260). For purposes of comparison of the information in graphs 320 and 330 (at block 250), processing of the measurements (shown in graph 330) and data (shown in graph 320) may include obtaining a fast Fourier transform (FFT), performing a bandpass filter of the FFT output, and obtaining a root-mean-square (RMS) for comparison.

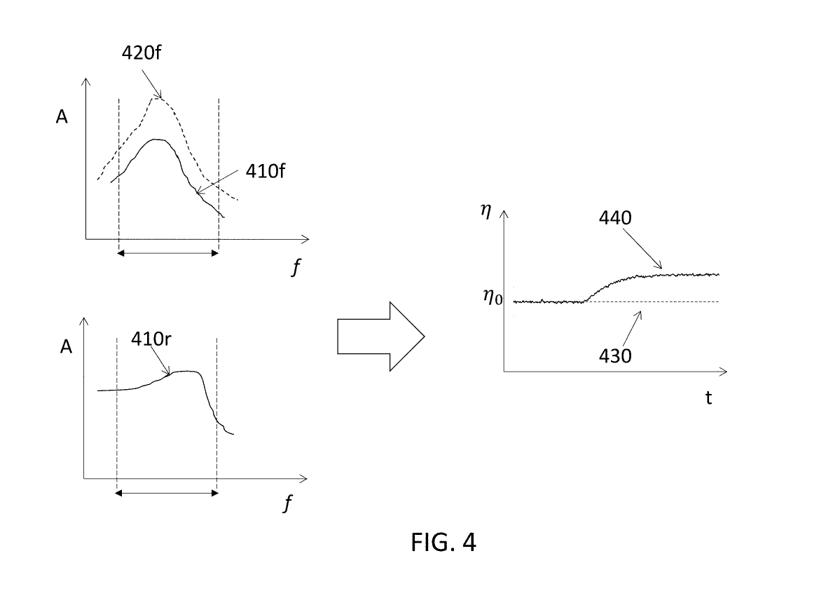

As previously noted, the angular wheel speed ω is a function of velocity V of the vehicle 100 as well as of DLR and results from a particular road excitation. FIG. 4 illustrates the development of benchmark η that readily indicates a fault in a damper 105. The graph 420f shows a response Y_{front}(s) (e.g., angular wheel speed ω) of a faulty damper 105 as amplitude A over the frequency domain f. A graph 410f of the frequency domain response for a normal damper 105 on the front wheel 105 is also shown for comparison. The graph 410r indicates a frequency domain response Yᵣₑₐᵣ(s) for a normal damper 105 on a rear wheel 105. The responses can be expressed as:

Y_{front}(s)=H_{front}(s)X(s) [EQ. 2]

Yᵣₑₐᵣ(s)=Hᵣₑₐᵣ(s)X(s) [EQ. 3]

In EQ.2, H_{front}(S) is the transfer function, in EQ. 3, Hᵣₑₐᵣ(s) is the transfer function, and X(s) is the road excitation in the frequency domain. The benchmark is then given by:

$$η = \frac{{Y}_{front} ( s )}{{Y}_{rear} ( s )} = \frac{{H}_{front} ( s )}{{H}_{rear} ( s )} \qquad [ EQ . 4 ]$$

As EQ. 4 indicates, the benchmark η is not a function of the road excitation X(s). As a result, the value of the benchmark η should remain constant unless one of the responses changes, indicating a change in response of one of the dampers 105. The graph 430 shows the constant value η₀ of the benchmark η over time.

The graph 440 shows the value of the benchmark η over time based on the faulty front damper 105 whose frequency domain response Y_{front}(s) is shown in graph 420f. Graph 440 readily indicates a fault in a damper 105, a time at which the fault is detected. The graph 440 also indicates that the fault has leveled off rather than continuing to increase, for example. The examples discussed with reference to FIGS. 3 and 4 are only two ways that estimates of the health state of a damper 105 may be obtained at block 250.

According to another exemplary embodiment, front Y_{front}(s) may be compared with Y_{model}(s) rather than Yᵣₑₐᵣ(s). Y_{model}(s) is obtained from H_{model}(s) from EQ. 1 and X(s), the actual road excitation used in EQ. 2, as:

Y_{model}(s)=H_{model}(s)X(s) [EQ. 5]

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of determining health state of a damper associated with a wheel of a vehicle using indirect measurements, the method comprising:
obtaining information from one or more sensors, wherein the one or more sensors includes a wheel speed sensor, inertial measurement unit, tire pressure sensor, steering wheel sensor, global positioning system (GPS) receiver, or a camera, and the information from at least one of the one or more sensors includes at least one measurement of a parameter not directly characterizing the damper; and
comparing the at least one measurement of the parameter with data of the parameter to estimate wear of the damper, wherein the data includes a historical measurement, a measurement for another wheel of the vehicle, a measurement from another vehicle, or an output of a model, and a maintenance or replacement task is triggered by the estimate of the wear of the damper.

2. The method according to claim 1, further comprising detecting an event based on the information, wherein the event includes a road excitation or a vehicle-based event.

3. The method according to claim 2, wherein the detecting the road excitation includes detecting a pothole or speed bump.

4. The method according to claim 2, wherein the detecting the vehicle-based event includes detecting braking or a door opening and closing to indicate entry of an occupant.

5. The method according to claim 2, wherein the comparing includes comparing the at least one measurement of the parameter with the data of the parameter during the event.

6. The method according to claim 1, wherein the comparing includes processing the at least one measurement and the data.

7. The method according to claim 6, wherein the processing includes performing a fast Fourier transform (FFT), filtering an output of the FFT, and obtaining a root-mean-square of an output of the filtering to obtain processed measurements of the parameter and processed data of the parameter.

8. The method according to claim 7, further comprising estimating the wear of the damper based on whether a difference between the processed measurements of the parameter and the processed data of the parameter exceeds a threshold.

9. The method according to claim 8, further comprising quantifying the wear of the damper based on an amount by which the parameter exceeds the threshold.

10. The method according to claim 1, further comprising issuing a message to indicate the estimate of the wear of the damper.

11. A system to determine a health state of a damper associated with a wheel of a vehicle using indirect measurements, the system comprising:
one or more sensors configured to obtain information, wherein the one or more sensors includes a wheel speed sensor, inertial measurement unit, tire pressure sensor, steering wheel sensor, global positioning system (GPS) receiver, or a camera, and the information from at least one of the one or more sensors includes at least one measurement of a parameter not directly characterizing the damper; and
a processor configured to compare the at least one measurement of the parameter with data of the parameter to estimate wear of the damper, wherein the data includes a historical measurement, a measurement for another wheel of the vehicle, a measurement from another vehicle, or an output of a model.

12. The system according to claim 11, wherein the processor is further configured to detect an event based on the information, wherein the event includes a road excitation or a vehicle-based event.

13. The system according to claim 12, wherein the road excitation includes detecting a pothole or speed bump.

14. The system according to claim 12, wherein the vehicle-based event includes braking or a door opening and closing to indicate entry of an occupant.

15. The system according to claim 12, wherein the processor is further configured to compare the at least one measurement of the parameter with the data of the parameter during the event.

16. The system according to claim 11, wherein the processor is further configured to process the at least one measurement and the data.

17. The system according to claim 16, wherein the processor is further configured to process the at least one measurement and the data by performing a fast Fourier transform (FFT), filtering an output of the FFT, and obtaining a root-mean-square of an output of the filtering to obtain processed measurements of the parameter and processed data of the parameter.

18. The system according to claim 17, wherein the processor is further configured to estimate the wear of the damper based on whether a difference between the processed measurements of the parameter and the processed data of the parameter exceeds a threshold.

19. The system according to claim 18, wherein the processor is further configured to quantify the wear of the damper based on an amount by which the parameter exceeds the threshold.

20. The system according to claim 11, wherein the processor is further configured to issue a message to indicate the estimate of the wear of the damper.
